(19) United States
(12) Patent Application Publication
(10) Pub. No.: US 2016/0376204 A1
(43) Pub. Date: Dec. 29, 2016

(54) Method for Reclaiming Usable Products from Biosolids

(71) Applicant: Nowa Technology, Inc., Prairie Village, KS (US)

(72) Inventors: Karl Wilke, Kansas City, MO (US); Eugene F. DeShazo, Prairie Village, KS (US); Bryan V. Yeh, Walnut Creek, CA (US)

(21) Appl. No.: 15/202,543

(22) Filed: Jul. 5, 2016

Related U.S. Application Data
(63) Continuation-in-part of application No. 14/094,391, filed on Dec. 2, 2013, now abandoned.
Application No. 14/094,391 is a continuation-in-part of application No. 13/840,750, filed on Mar. 15, 2013, now abandoned.
Application No. 14/094,391 is a continuation-in-part of application No. 12/831,997, filed on Jul. 7, 2010, now abandoned.
(60) Provisional application No. 61/625,831, filed on Apr. 18, 2012.
(60) Provisional application No. 61/223,617, filed on Jul. 7, 2009.

(51) Int. Cl. C05F 7/00; C02F 11/12; B01D 11/04; C02F 11/00

(52) U.S. Cl. CPC C05F 7/00; C02F 11/002; C02F 11/004; C02F 11/12; B01D 11/0426; B01D 2011/002

(57) ABSTRACT

A method of reclaiming usable products from sludge is disclosed. A predetermined level of solvent within an extractor is heated, below atmospheric boiling point, and dried sludge is immersed within the headed solvent. The solvent is a non-polar or polar aprotic solvents, such as heptane. The non-solid products, an oil/solvent mixture are separated from the solids and transferred to at least one evaporator with a concentration of between 2-25% oil in the solvent. The oil and solvent are separated in one or more evaporators to remove approximately 70%-95%, and preferably 85%-99%, of the solvent. The solids are moved to a desolventizer for removal of the residual solvent and are then dried to a moisture content of below 25%, and preferably between 10%-15%.

### CROSS REFERENCE

This application is a Continuation in Part of pending U.S. Ser. No. 14/094,391 filed Dec. 2, 2013 which is a Continuation in Part of pending U.S. Ser. No. 13/840,750 filed Mar. 15, 2013 which is a non-provisional of U.S. 61/625,831 Filed Apr. 18, 2012 and pending U.S. Ser. No. 12/831,997 filed Jul. 7, 2010 which is a non-provisional of U.S. 61/223,617 filed Jul. 7, 2009, all of which are incorporated herein as though cited in full.

### SUMMARY OF THE INVENTION

The disclosed invention relates to an improved method of reclaiming usable products, such as oil, soil amendment and fertilizer, from biosolids.

### BACKGROUND OF THE INVENTION

Wastewater sludge treatment and disposal cause some difficult and expensive challenges for municipalities with wastewater treatment systems. On average, about 6.5 million metric tons of sludge (on a dry basis) is produced each year in the U.S. alone (Water Environment Federation, 2008). This adds up to a disposal cost of more than $1 billion per year. As an example, the cities of Reno and Sparks, with a population of about 300,000 produce 30 million gallons per day of sewage, 120 tons per day of sludge and 18 tons per day of solids (dry basis).

A vast majority of that is either put in landfills, used as a soil amendment, fertilizer, or incinerated, all of which are becoming increasingly expensive and cause various degrees of environmental concerns (Dufreche et. al., 2007). Another option, which has gained attention recently, is to use the processed sludge as an energy source. Different types of sludge have significantly different compositions. Primary sludge is taken from the initial filtering and settling and varies greatly in composition. Activated and secondary sludge are produced in aerobic digestion and contain bacteria and other microorganisms. Digested sludge is taken after an anaerobic digestion process. Since it contains anaerobic organisms which do not survive in climates with oxygen, digested sludge is a relatively benign substance which makes handling and storage easier. Several studies have examined extracting oils with a variety of solvents from different kinds of sludge for use in biodiesel production, all with limited effectiveness. This project explores the possibility of using digested sludge with alternative solvents as a source for extraction of oils, as opposed to types of sludge obtained from earlier in the sewage treatment process.

Various sewage treatment methods and plants are known in the art. Wastewater treatment operations use three or four distinct stages of treatment to remove harmful contaminants; according to the United Nations Environmental Program Division of Technology, Industry, and Economics Newsletter and Technical Publications Freshwater Management Series No. 1, “Biosolids Management: An Environmentally Sound Approach for Managing Sewage Treatment Plant Sludge” which goes on to say: “Each of these stages mimics and accelerates processes that occur in nature.

In the prior art a hexane/methanol/acetone solvent has been reported to extract 27.43 wt % of oils from activated sludge, but only 4.41 wt % of the activated sludge was saponifiable for production of biodiesel (Dufreche et. al., 2007). In-situ transesterification using methanol as an extraction solvent and reactant and sulfuric acid as a catalyst was reported to convert 14.5 wt % of biosolids in primary sludge into biodiesel (Mondala et. al., 2009). Another study reported yields of about 11.88 wt % of biodiesel from primary sludge using Soxhlet extraction method and a hexane/methanol/acetone mixture as the solvent (Willson et. al., 2010).

The removal of oil from waste, in this case hazardous wastes, was disclosed in U.S. Pat. No. 5,092,983 Eppig et al. Eppig, however, requires the use of two solvents having defined dissolving ratios and boiling points, creating a complex and expensive system requiring additional equipment than a single solvent system. Eppig further teaches that the oil is extracted prior to contact with the first solvent

### BRIEF DESCRIPTION OF DRAWINGS

FIG. 1 is a flow chart depicting the entire process;

FIG. 2 is a flow chart depicting only the solvent recovery portion of the process in accordance with the invention;

FIG. 3 is a flow chart depicting only the oil recovery portion of the process in accordance with the invention;

FIG. 4 is a flow chart depicting only the miscella to the first evaporation stage in accordance with the invention;

FIG. 5 is a flow chart depicting only the water in the process in accordance with the invention; and

FIG. 6 is a diagram of the continuous countercurrent belt extractor process in accordance with the invention.

### DETAILED DESCRIPTION OF THE INVENTION

Definitions

As used in herein the term “biosolids” shall relate to the product generated from tertiary treatment of waste activated sludge as well as treated human waste.

As used in herein the term “sludge” shall relate to the product generated from municipal wastewater sludge including primary sludge, secondary sludge, treated sludge, activate sludge, as well as treated human waste.

As used in herein the term “solid” shall relate to the product remaining after extraction of the miscella from the sludge within the extractor.

As used in herein the term “fines” shall relate to the very small particles found in mining, milling, etc.

As used herein the term “miscella” shall relate to a solution of mixture containing an extracted oil or grease.

As used herein the term “DT” shall refer to a desolventizer-toaster.

As used herein the term “DTD” shall refer to a unit containing a desolventizer-toaster and dryer cooler.

As used herein the term “POTW” shall refer to the publically owned treatment works as is used in the United States for a treatment plant that is owned, and usually operated, by a government agency. In the U.S., POTWs are typically owned by local government agencies, and are usually designed to treat domestic sewage and not industrial wastewater.

As used herein the term “about” means a range of +/−15%.

As used herein the term percent (%), means percent by weight.

Different types of sludge have significantly different compositions. Primary sludge is taken from the initial filtering and settling and varies greatly in composition. Activated and secondary sludge are produced in aerobic digestion and contain bacteria and other microorganisms. Digested sludge is taken after an anaerobic digestion process. Since it contains anaerobic organisms which do not survive in climates with oxygen, digested sludge is a relatively benign substance which makes handling and storage easier. Many treatment plants produce mixtures of sludge taken from different points throughout the wastewater treatment process.

The disclosed process provides numerous advantages over the prior art. First, it improves the quality of biosolids generated by wastewater treatment plants to enable its widespread use as a soil amendment or fertilizer. The biosolids processed through the disclosed system are cleaner due to the solvent extraction removing oil, thereby containing minimal contaminants leaching out into the soil. This allows for wide spread use as a fertilizer and soil amendment. Further, removal of the oil makes the resulting soil amendment or fertilizer hydrophilic.

Second, the solvent extraction and solvent removal step provides for multiple kill steps to eliminate, the pathogen level of the material, making it safer to handle. This is done without alkaline treatment, thus keeping the, material at a neutral pH.

Third, the oily material that is removed can be used to provide heat to the process. As noted above, however, the quantity of extracted oil is dependent upon the contents of the sludge.

A fourth and essential feature is the efficient recovery of solvent that has a major positive impact on the economics of the process.

Fifth, only a single solvent is required in the process.

Finally the disclosed process is more economical to run than prior art designs and methods. The boiler, which can be run from the reclaimed oil, can be the solitary heat source for the system, although outside heat sources could be used. Recovered solvent is fed to the solvent inlet of the extractor for reuse with a less than 500 parts per million solvent loss, giving a 99.6 solvent reuse. The expected steam consumption from this process is expected to be around 500 lbs. per ton of dry sludge processes. This takes into consideration the various heat exchange opportunities that are available based on a pinch analysis that was performed on the process. However, the amount of steam that is used in the process is also dictated and proportional to the amount of oil extracted from the incoming sludge. The 500 pounds of steam per ton reference is expected when the oil extracted is between 15-10% of the mass of the incoming sludge, however, if the oil contains around 7% oil, then the steam usage will drop to around 300 pounds of steam per ton. The reduction of steam is due to two factors: 1) the reduction of solvent required to extract the oil, and 2) the reduction of material that needs to be desolventized and distilled. Note that the relationship is not linear as there will be a minimum requirement for steam that is the threshold of the process.

The expected electrical consumption for the process is 25 kilowatt-hours per ton. Unlike steam consumption, the electrical consumption does not vary with oil concentration since it is energy that is used for conveying and is proportional to rate.

Currently the trend in the industry is for combined heat and power extraction for use in generating electricity as well as producing fertilizer and soil amendments. Due to the difficulties encountered, oil extraction is rare, or non-existent.

Wastewater sludge is the product of wastewater treatment plants and consists of matter consisting of municipal sewage and a more detailed list can be viewed on. Wikipedia.org/wiki/Wastewater#Origin. Although broad the breadth of the material fed into the process is consistent.

Because sludge is the aggregate of solids removed from wastewater in the treatment process, sludge is itself a waste product. Therefore, a certain variability exists. However, the range of that variability is relatively narrow. For example, all sludge contains about 25-36% metals and inerts (the remaining ash when a sludge sample is asked at 500 deg. C). All sludge contains between 4% and 12% extractable oil. (Note, on a laboratory basis, using a blend of solvents and a high temperature, high pressure extractor, more oil can be extracted, but the process is not scalable beyond the laboratory bench). See, Wastewater Engineering Treatment and Reuse, Metcalf and Eddy (Fourth Ed. 2003) pp. 1451-1457 (Pg. 1-7 Addendum A); Wastewater Sludge Processing, Turovskiiy and Mathai (2006), at p. 45 (Pg. 8-11 Addendum A); and Extraction of Lipids from Municipal Wastewater Plant Microorganisms for Production of Biodiesel, Dufreche, et. al. J Amer Oil Chem Soc (2007) 84:181-187¹.

The similarity of sludge is discussed in the book Wastewater Engineering Treatment and Reuse, Fourth Edition, by Metcalf & Eddy Inc., (Pg 1-7) wherein it is stated that untreated sludge and digested biosolids have a typical chemical composition, although quantities will differ to some extent. It should be noted that the publication by Metcalf & Eddy is considered the primary reference material for those involved in wastewater processes.

The sources for wastewater are predominately the same with some obvious variations based on local diet. Wastewater from New York City will have the same contents as Lewellan, Nebraska. Quantities will differ however content will typically be the same.

Each facility can be customized to the contents of the sludge through testing at the time of design, to determine the time required for the process, including drying solvent immersion time, etc. A standard facility can be used in any location, however the process times can vary from facility to facility. The processed sludge from wastewater plants contains a reduced amount of bacteria. Any remaining bacterial is killed during the disclosed process, thereby producing a clean, environmental friendly soil amendment and/or fertilizer. All publications referred to herein are incorporated by reference as though recited in full.

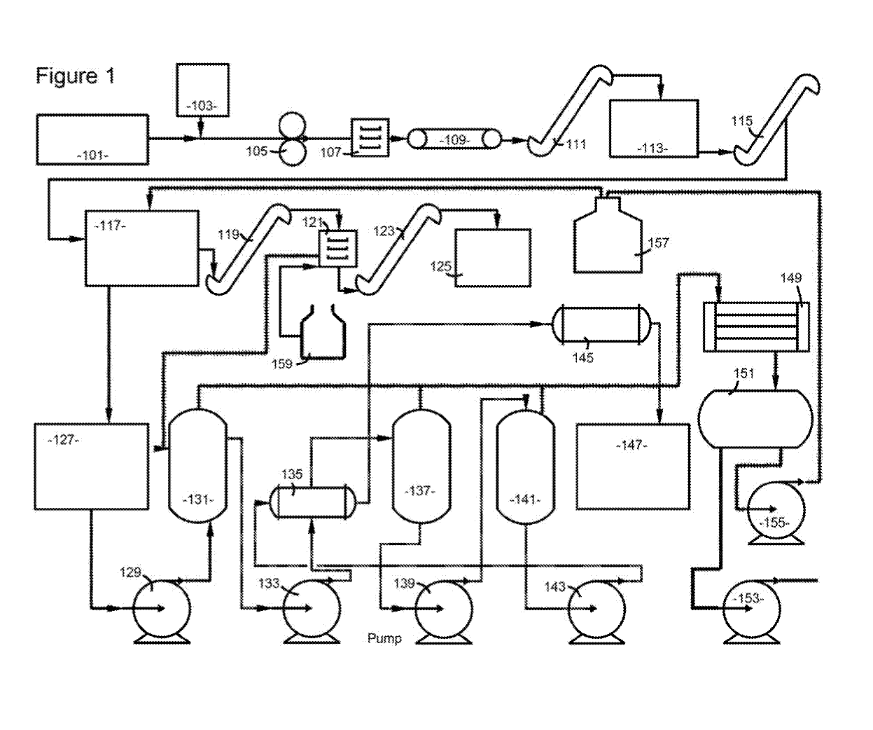

As shown in FIG. 1, sludge is generated at the POTW 101 by either anaerobic digestion or aerobic digestion of wastewater. At some plants, the generated sludge undergoes further anaerobic digestion to reduce the volume of sludge handled. Regardless of whether or not the sludge has undergone further digestion, the sludge can still be processed by the disclosed process. From the standpoint of the disclosed process, the processing point of the sludge, does not matter so the sludge can be primary, secondary or tertiary.

Before the sludge leaves the POTW 101, it is dewatered to reduce the volume of the product. Belt presses are the most common dewatering devices in waste water treatment and can achieve anywhere between 10-35% solids (90%-65% moisture) after processing.

The second sludge source is the fat, oil, and grease (FOG) 103. This includes animal fats, vegetable fats, and oils. A byproduct of cooking, FOG 103 comes from meat, fats, lard, oil, shortening, butter, margarine, food scraps, sauces, and dairy products. The FOG 103 is a solid or viscous substance, which will ultimately create an obstruction in the sewer system if not properly disposed. When washed down the drain, FOG sticks to the inside of sewer pipes. Over time FOG can build up, block entire pipes, and lead to serious problems.

The FOG 103 is often removed early in the processing of wastewater at the water treatment plant and treated separately through an anaerobic digester specifically designed to break down the FOG 103. However, using the disclosed process, this step may be skipped and the FOG 103 added directly to the sludge after it has been dewatered.

The sludge received from the POTW 101 and FOG 103 proceeds to the sludge dryer 107, via sludge transfer pump 105, since to further process the sludge, it needs to be dried to anywhere between about 65%-99% solids (20% to 1% moisture), preferably between 88-92% solids (8% to 12% moisture). A moisture content between 25%-30% moisture does not produce consistent results with respect to the removal of oil and other materials from the remaining solids. The length of time will be dependent upon the content of the sludge, as well as size and type of dryer. Drying to a moisture content of below 10% has been found to be economically inefficient.

There are many different dryer designs for drying sludge, such as a paddle dryer, ring dryer, flash dryer and equivalents as known in the field. For this process, a flash dryer, paddle dryer or hollow screw dryer are preferred due to energy efficiency and the ability to preserve the size of the particle. An example would be a hollow screw dryer that will consume between 1300-1600 BTU per pound of water removed from the sludge. It should be noted, however, that the system will work with other driers that can be substituted that provide the equivalent results. The dried biosolid is transferred away from the sludge dryer 107 via the sludge discharge conveyor 109. There are many ways of conveying and depending on the layout, multiple conveyors can be used. For example, in the illustrated embodiment the dried biosolid is transferred from the discharge conveyor 109 to a dried sludge transfer conveyer 111 The transfer conveyor 111 moves the sludge onward to the dried sludge storage tank 113. Alternatively the dried sludge could be transported directly from the dryer 107 to the storage tank 113. The method of transporting the sludge will be known to those in the art.

The dried sludge storage tank 113 stores the sludge rather than moving it straight to the next process to act as a buffer between processes. As some parts of the system are processed through faster than others, the dried sludge storage tank 113 prevents the later processes from being overloaded with too much sludge. This enables further steps to take from the bin on an “as needed” basis. The dried sludge can stored anywhere from 15 minutes to indefinitely, depending on delivery, remaining equipment and work schedules, before moving to the next process. The dried sludge storage tank 113 size is in the range necessary to detain between 15 minutes to three days of dried sludge production. The dried sludge storage tank 113 is preferably vented to release moisture, is preferably lined or clad with a corrosion resistant material, and it preferably has an unloading device on the bottom to assist in removing the material should the material be susceptible to bridging.

The dried sludge is transferred away from the dried sludge storage tank 113 via the extractor feed conveyor 115 or other applicable transportation means. The conveyor moves the sludge to a continuous solvent extractor 117.

The solvent extractor 117 removes the oil and any impurities that could have leached into the soil and aids in the destruction of pathogens. The extraction time is between 0.5-6 hours with 4 hours being preferred. The extraction time is determined by the size and type of the extractor and the contents of the sludge.

The vapors from the solvent exit the vapor port 314 for the condenser and subsequent recovery. The miscella leaves through the miscella port 310 for subsequent solvent recovery.

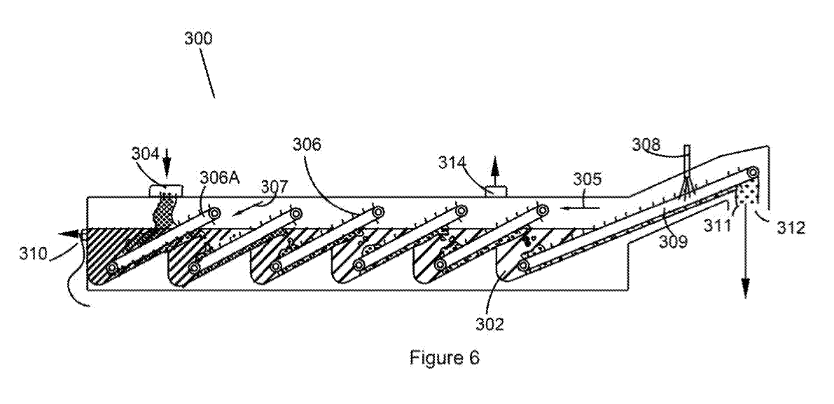

The preferred extractor 117 is a counter-current immersion extractor 300 as illustrated in FIG. 6. Alternatively, the extractor can be a percolation type, although immersion is the preferred embodiment. An example of an immersion device is the Model IV manufactured by the Crown Iron Works at Minneapolis, Minn. and Model V being an example of percolation extraction. Additional data on reclaiming oil and fertilizer using a percolation extractor system can be found in co-pending application Ser. No. 12/831,997, filed Jul. 7, 2010 which is incorporated herein by reference. An immersion extractor is easier to operate than other forms of extractors, and can handle all levels of sludge as well as all particle sizes.

Although any organic polar or nonpolar solvent can be used, it has been found, that in industrial scale applications Heptane separates the greatest percentage of oil and other materials from the solids with minimum power expenditure. Water, as well as benzene and other extreme polar solvents, will not extract the oil from the sludge. Further, using the disclosed system a single solvent can be used to separate the oil and toxins from the solids.

The extractor 117 is designed to be able to be set to an operation temperature at less than the atmospheric boiling point of the solvent of choice. Although close to, or 10° F.-20° F. degrees below the boiling point of the solvent produces the highest oil output, the gain rapidly diminishes with increasing temperature. For example it has been found that heptane, which boils at 209.2° F., extracts more oil at 184° F. than at 70° F.

The rate of solvent addition is such that a concentration between 2%-25% oil in the solvent is achieved with the preferred concentration being between 4%-20%. The extractor can have a mechanism to allow for gravity flow dewatering to occur for any additional moisture before the solids are discharged into the extractor discharge conveyor 119. The solvent content of the solids upon exiting the extractor is between 10%-30% solvent.

The liquid that exits the extractor is known as miscella and contains essentially all of the oil contained within the sludge. The miscella generally comprises between 2%-25% solvent soluble materials (oil). The liquid flows into a tank known as the miscella tank 127 where it is held prior to distillation. The distillation process takes generally under 5 hours with 30-60 minutes being preferred. The tank size commonly used for oil production would most likely complete distillation in the range of 2-4 hours, although smaller or larger tanks can be used. The size of the tank would depend upon the size of the plant, work schedules, etc. The materials separated by the distillation are the oil contained in the sludge and the solvent. After distillation the oil is free of solvent. The amount of oil recovered is inconsistent and varies greatly by region and time of year with the percentages being as 2% and as high as 18% of the volume of sludge. The oil meets many of the specifications identified with what is commonly called “Medium” crude and can be, used as a crude oil blend stock but at which percentages would have to be specified by the refiner. As a fuel oil, it meets the standard defined by ASTM D396 for fuel oil number 6 and can be used currently as a bunker fuel throughout the world. The oil can also be used as a binder for making bio-asphalt. Other uses will be known to those skilled in the art.

Once the extraction process is completed, the sludge goes on to the extractor discharge conveyor 119 towards the DT 121.

The distillation pump 129 serves the purpose of transferring the oil/solvent mixture into the 1^{st} stage evaporator 131.

After the miscella tank 127, the miscella is pumped, through use of a distillation pump 129, into the 1^{st} stage evaporator 131, such as a still, rising film evaporator, and equivalent equipment that can remove the solvent from the oil. The 1st stage evaporator 131 serves the purpose of utilizing waste heat from the desolventizer and/or boiler heat to separate about 70%-95%, with optimally 80%-90% of the solvent from the oil/solvent mixture. Any type of evaporator can be used including still, rising film, falling film, wiped film and short path. In a rising film evaporator, boiling takes place inside the tubes, due to heating (usually by steam) of the outside of the tubes. With this process submergence extraction is therefore not required; as the creation of moisture vapor bubbles inside the tube creates an upward flow enhancing the heat transfer coefficient. This type of evaporator is therefore quite efficient, the disadvantage being to be prone to quick scaling of the internal surface of the tubes. Tubes are usually quite long (4+ meters) and sometimes a small recycle is provided. Sizing this type of evaporator is usually a delicate task, since it requires a precise evaluation of the actual level of the process liquor inside the tubes. Further details regarding evaporation are found in U.S. Pat. No. 5,582,692 which is incorporated by reference herein.

Heat to the 1^{st} stage evaporator 131 is provided by the hot vapors coming out of the boiler 159, which if desired can pass through desolventizer 121 depending upon plant design. Once the latent heat from the hot vapors are recovered, the condensed vapors flow from the 1^{st} stage evaporator 131 to the solvent water separator 151, where the solvent and water are separated. The solvent is then transferred, via the solvent transfer pump 155, back to the storage tank 157 for reuse. The water is sent to waste water disposal pump 153 and then back to the boiler 159 for reuse or alternatively to the POTW 101 or other disposal areas. In the head section of the 1^{st} stage evaporator 131, the solvent vapors travel to a condenser 149 where it is condensed prior to being sent to the solvent water separator 151. The remaining miscella leaves the evaporator 131 containing on average about 75-85% oil and 25-15% solvent, and generally 80% oil and 20% solvent. The oil/solvent percentages will vary based upon the type of evaporator.

The 2nd stage feed pump 133 serves the purpose of transferring the oil/solvent mixture from the 1^{st} stage evaporator to 2^{nd} Stage evaporator 137. Prior to entering the 2^{nd} stage evaporator 137, the mixture goes through a heat exchanger 135. The heat exchanger 135 preheats the feed into the 2^{nd} stage evaporator 137 with the oil from the stripper 141 to ensure that the mixture remains in vaporous stage. This heat recovery increases the temperature of the miscella to the degree required to maintain this vaporous stage, which is generally by about 200° F. The oil cooler 145 cools the oil from the heat exchanger 135 with cooling water, taking the oil from a temperature of approximately 140° F.-200° F. to a temperature of approximately 100° F.-130° F. The cooling water is brought into the equipment from any available, applicable source.

After cooling the oil has completed its processing and is stored in the oil storage tank 147. The oil can then be used to as heat for the process, a bunker fuel, asphalt enhancer, lubricant, to supplement crude oil or for any other use depending on the purity of the oil recovered. The oil composition is dependent on the quality of sludge and can vary greatly.

The 2nd stage evaporator 137 sues the purpose of further separating the solvent from the oil. As with the 1st stage evaporator 131, any type of evaporator may be used including rising film, still, rising film, failing film, wiped film and short path. Heat to the evaporator 137 is provided by plant steam or outside sources. As with the solvent, vapors from the 1^{st} stage evaporator 131, the vapors from the 2^{nd} stage evaporator travel to the condenser 149 where it is condensed, and then transferred to the solvent water separator 151. The remaining miscella leaves the second stage evaporator 137 containing about 97%-99.9% oil and 0%-3% solvent.

The miscella from the 2nd stage evaporator 137 then travels to the oil stripper 141; powered by the stripper feed pump 139. In the oil stripper 141, the miscella travels counter current to sparge steam that is used to strip away the remaining solvent with the solvent riding up on the steam out of the oil stripper 141. Different internal designs for the oil stripper 141 may be used including random packing, sieve tray and disk and donut. In this system, a disk and donut configuration is preferred. The oil is discharged out of the oil stripper 141 containing less than about 500 parts per million of solvent. Solvent vapors from the oil stripper 141 travel to the condenser 149 where it is condensed, and then goes to the solvent water separator 151. Due to the very low remaining solvent, roughly 99% of the solvent used in the process is recovered. Further details regarding oil stripping using disc and donut is found in U.S. Pat. Nos. 3,503,854 and 6,703,227, which are incorporated by reference herein.

The stripper discharge pump 143 serves the purpose of removing the oil from the stripper 141. The materials are processed back to the heat exchanger 135 and then onto the oil cooler 145 and storage tank 147 The resulting oil may be used directly in a boiler 159 for generating heat within the system of commercial uses as described heretofore.

The solids are transferred away from the extractor 117 via the extractor discharge conveyor 119. The conveyor 119 moves the solids to the desolventizer 121. At this point the solids are of the composition of about 30% solvent and about 70% percent oil free solids.

The desolventizer 121 serves the purpose of removing any remaining solvent from the solids and drying and cooling the solids so that it is suitable for storage. Although a single desolventizer unit is illustrated herein, separate units, with transferring means between the DT and DC, can be used. The solids are desolventized using an apparatus commonly known in the oilseed industry as a desolventizer-toaster, or equivalent. The apparatus uses a combination of agitation, indirect heat and, if desired, a condensable inert gas as a stripping medium. In this system, steam, which comes from a boiler 159, is the preferred stripping gas. The operating temperature of the desolventizer-toaster 121 is preferably between about 220° F.-250° F. and with the solids remaining in the desolventizer a mean residence time between about 15-30 minutes, or until the desired moisture content is reached. The solids leaving the desolventizer, or alternatively DT, preferably contain no more than 300 ppm of solvent, and will have a moisture content between about 5%-20%. Further details regarding DTDC and general desolventizers are in U.S. Pat. No. 5,992,050, which is incorporated by reference herein.

In some embodiments, such as the example illustrated herein, after the desolventizer 121, the solids will flow into a DC. The DC allows for heated air to further dry the material and is followed by a flow of ambient air to cool the material before storage.

The dried solids are transferred away from the desolventizer 121 via the discharge conveyor 123. The conveyor moves the sludge to the finished sludge storage tank 125.

At the finished sludge storage tank 125 the residual solids are of the composition of about 90% solids and 10% moisture. The biosolids are cleaner and pathogens eliminated, meaning there will be no pathogens leaching out into the soil and is thus is safe to handle. Meets Class A Exceptional Quality Biosolides as set by Code 40 CFR part 503. The final residual solids can be used for a high value fertilizer/soil amendment.

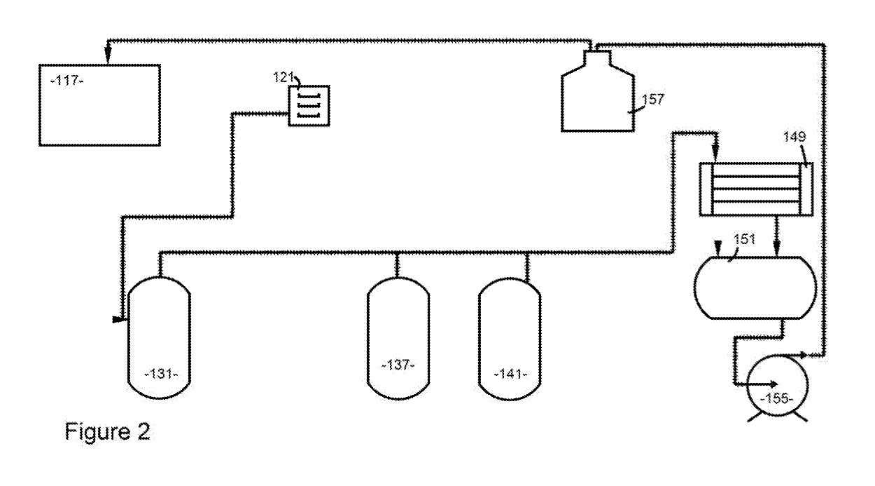

FIG. 2 shows in more detail only the solvent portion of the system. The solvent starts in the solvent storage tank 157 and enters the process at the extractor 117. The solvent also enters the 1st Stage evaporator 131 from the desolventizer 121 and the extractor 117. The solvent then proceeds from the 1st Stage evaporator 131 to the 2nd Stage evaporator 137, the Oil Stripper 141, the condenser 149 and the solvent water separator 151. From the solvent water separator 151 the solvent goes to the solvent transfer pump 155 back to the solvent storage tank 157.

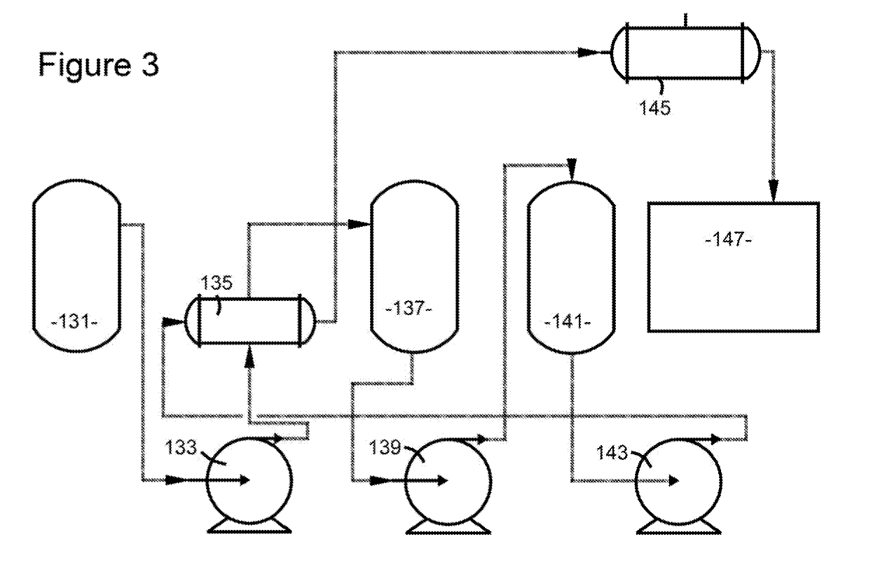

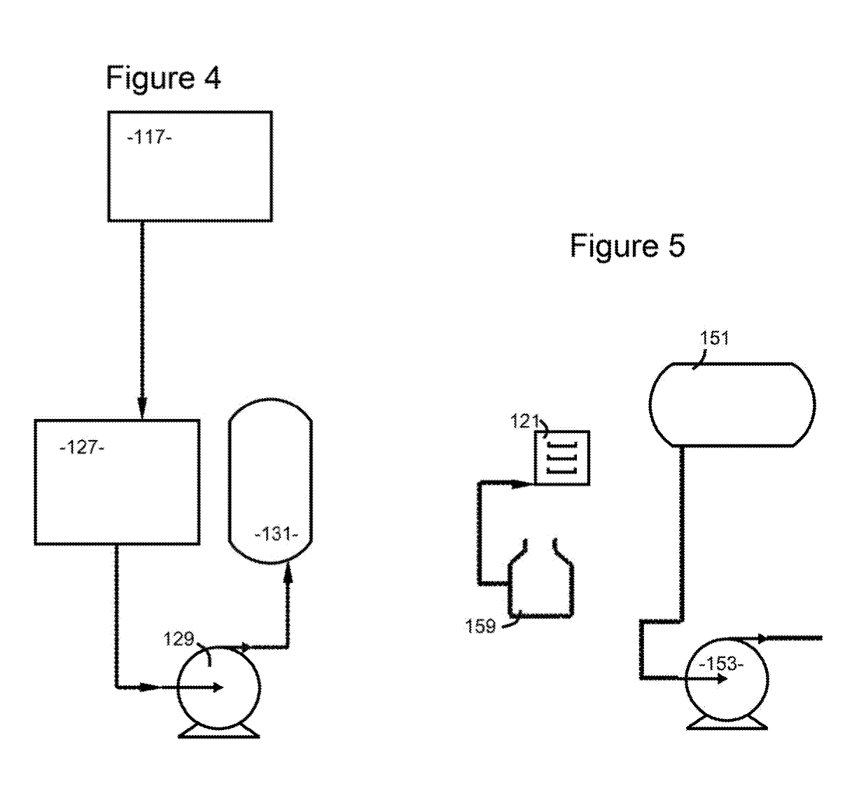

FIG. 3 shows the path of the oil starting at the 1st Stage evaporator 131 going through the 2nd stage feed pump 133 to the heat exchanger 135. From there it either goes from the 2nd stage evaporator 137 on to the stripper pump 139 then to the oil stripper 141 to the stripper discharge pump 143 and back to heat exchanger 135 to the oil cooler 145 to the final oil storage tank 147. FIG. 4 shows the first evaporation stage of the miscella. It starts in the extractor 117, goes on to the miscella tank 127, then on to the distillation pump 129 on to the 1st stage evaporator 131.

FIG. 5 shows the steam going from the boiler 159 to the desolventizer 121 and the water from the solvent water separator 151 going to the waste water pump 153.

The preferred extractor is a continuous feed counter-current immersion solvent extractor 300, as illustrated in FIG. 6, rather than extractors such as Soxhlet and Parr, as it thoroughly separates the finished solids and the oil laden solvent. For optimum results the extractor must have transfer members, such as belts, with the ability to turn over the solids throughout the process; be capable of countercurrent solvent/solid movement; a solids removal member elevating the solids above the solvent bath to the dissolver discharge port and a solvent port to spray the removed solids with clean solvent prior to discharge. Although the extractor illustrated uses belts it should be noted that any extractor design meeting the disclosed criteria. Another example would be a screw feed Kennedy extractor that uses paddles to move the solids through the interior until reaching the exiting conveyor. Extractors that do not meeting the disclosed criteria leave the finished solids and oil laden solvent together, allowing some of the extracted oil to go back into the exiting solids.

With the disclosed counter-current immersion process, the solids are bathed and turned over throughout the extraction process and the finished solids are subsequently washed with clean solvent after leaving the bath. This virtually clean solvent enters the extraction bath as the finished solids exit. At the opposite end the entering solids are mixed with oil laden solvent. As the solids move through the bath in the opposite flow of the solvent and more oil is extracted, the solids are exposed to cleaner solvent to prevent the extracted oil from going back into the finished solids.

The counter-current flow of solvent through the solid extraction process coupled with a material turnover at each belt to belt transfer, produces a greater extraction rate than prior test results. The material is turned over as it drops from one belt to the next, preventing the solids from clumping together and permitting the solvent better access to particles.

The longer the solids are processed the more critical the use of cleaner or “fresher” the solvent as the longer the extraction time the more oil that is removed from the solids into the solvent. Without the addition of clean solvent the oil within the solvent builds up to be equal to the oil within the solids, preventing any additional removal. To prevent the equalization between oil and solvent, fresh solvent is continually added at about the rate of miscella exiting the system. In addition to renewing the solvent and maintaining a consistent level within the extractor chamber 302, the solids are conveyed up an inclined exit belt 309 when exiting the extraction bath; the bathing of the solids prior to exiting the desolventizer port 312 greatly reduces the residual solvent in the solids.

Using the disclosed counter-current solvent immersion extraction process, the solids are washed with ever purer solvent in the immersion bath as the solids are processed along the belts 306.

Although the extractor can be a batch feed, a continuous feed is preferred as it reduces equipment costs and operates at a lower temperature which reduces energy costs as well as startup costs. Further, it has been found that the continuous process produces a better quality of oil than the batch process at lower temperature and a fraction of the pressure required by the batch process. Pressure and temperature was able to be reduced from around 7 bar and around 350° F. to around 1 bar and under 230° F. The motor size was able to be reduced using the continuous feed, providing, further savings.

Although unexpected, it has been found that the solvent required to more thoroughly clean the solids than in the batch process was able to be reduced to about a fifth the quantity required in the batch process. A continuous extractor can be a co-current or countercurrent, although countercurrent is the preferred embodiment. A co-current continuous extractor leaves the oil laden solvent and the finish solids together, allowing extracted oil to absorb or adsorb back into the finish solids. Using a co-current continuous extraction the final extraction percentage is less than the same biosolids being processed through a counter current extraction process.

After looking at many different continuous extraction options, the industrial continuous extractor that continually moved the material and turn it over while moving solvent against the material flow was selected. Even though the standard equipment did not allow pressures higher than atmospheric pressure, proof of concept tests were conducted, baseline test data collected and a list of alterations implement. The proof of concept tests, in unmodified equipment, demonstrated that the material would move against the counter current solvent flow rates above 4 times the weight of solid flow.

The proof of concept consistently achieved about the same or better extraction than other extraction systems tested at the lab and industrial scale without temperature and pressure modifications. The adjustment of solid flow rate, solvent flow rate, temperature and immersion time for particular sludge, produced consistent oil extraction rates at about atmospheric pressure. After that demonstration and the collection of baseline data, the equipment improvements increased the temperature to about 250° F. and pressure of the counter-current continuous process to about 300 psi. **are batch process and continuous different equipment? If so did anything other than temperature and pressure need modification?

The counter-current immersion process has better results on an industrial scale than lab results using Soxhlet and Parr extractors that left the finished solids and the oil laden solvent together and allowing some of the extracted oil to go back into the exiting solids. The bathing of the finished solids prior to exiting the counter-current immersion process prevents the extracted oil from going back into the finished solids. Since different labs had similar results using the same equipment setup, the difference between the lab equipment process and the counter-current immersion process was explored. The plant having counter-current flow of solvent through the solid extraction process coupled with material turnover produced a greater extraction rate than the labs. The improved results are a result of clean or “fresher” a solvent rinsing the solids after being removed from the oil containing solvents. As the solids are being washed with the solvent, more oil is extracted, with an increase in the oil to solvent ration the longer the solids are processed. Using the disclosed counter-current solvent immersion extraction process, the solids are washed with ever purer solvent in the immersion bath as the solid are processed longer in the bath. With a final rinsing spray after the solids leave the bath, the solids are cleaned from the extractable oils.

Additional baseline data was gathered in a comparison between batch and continuous feed disclosing that continuous feed has about the same oil extraction as the batch process runs and with a better quality of oil. The extraction using the continuous process used an even lower temperature than the batch process, at a small fraction of the batch process's pressure, running a smaller motor at few hundred times slower, and only using about half the solvent.

The continuous extraction process greatly improves the solvent recovery during solid solvent separation and oil solvent exit. The first step uses gravity on an enclosed incline to separate about the same solvent as filtration without the need to clean and replace filters, which cause addition solvent loss. The second step uses a continuous step of heating and turning the material to prevent the solids from clumping together and inhibiting the solvent from evaporating from the solid clump's center.

A six (6) belt continuous countercurrent extractor 300 is illustrated in FIG. 6. The number of belts will be dependent upon the size of the operation and more or fewer belts can be used. The solvent is added up to level that will maintain the sludge submerged during the process, prior to the sludge being moved into the extractor 300. The temperature is raised to about 180° F. prior to the addition of the initial batch of solids and maintained at about 180° F. throughout the process. The solvent moves from the solvent input port 308 to the miscella exit port 310 creating a current, indicated by arrow 305, against which the solids travel.

The sludge enters the extractor chamber 302 at the sludge input port 304 where contact is made with the first belts 306A which, in this example would be rotating counterclockwise as noted by arrow 307. The sludge moves along the belts 306, dropping with each sequential belt. At each drop, the material is turned over to prevent clumping or turning into bricks. Further, the material turnover aids solvent penetration and prevents issues relating to material suspension during tank mixing. The dropping of material from one inclined bench to another, or otherwise turning over the sludge, removes the need to add mixers to suspend solids and prevents solids from settling at the bottom a the vessel, since the belts 306 continuously move solids from the bottom of the vessel.

The solvent input port 308 is raised from the chamber 302 to contact the exiting solids 311 subsequent to removal from the solvent within the chamber 302 and prior to exiting the extractor at desolventizer port 312. As the solvent enters the extractor 300 at a level higher than the solvent containing chamber 302, the entering solvent starts the counter-current solvent flow in the opposite direction from the progress of the sludge along the belts 306. This flow is maintaining by the flow out through miscella port 310. The majority of the solvent is recovered for reuse in the system, thereby reducing the costs of operation. **how far above the chamber is the input port and at what angle or does it matter? What pressure is used? **

Within the enclosed extraction equipment, the solids 311 are turned over to at the last belt to exit the solvent bath slowly conveyed up the inclined exit belt 309. This step uses gravity to separate about the same percentage of solvent as filtration by filter press or belt press without vapor loss or the need to scrap, clean and replace filters. It is as this point that the solids 311 contact the fresh solvent entering the system at the solvent input port 308, thereby washing the exiting solids 311 of additional solvent.

The placement of the input port 304 and rotation of the belts 306 should be such that the sludge travels down the first belt 306A to the bottom of the chamber 302 and does not exit the miscella port 310. Further the miscella port 310 should be positioned just below the solvent level to avoid pulling the sludge from the chamber 302. As the oil laden solvent goes to leave through the miscella port 310 the a lower portion of the chamber 302 serves as a settling area to allow the solids caught in the current of the solid to drop and be caught up in the rotation of the first belt 306A.

The solvent can be reused with minimal cleaning basically forever with a fraction of a factional percent needing to be replace with each use. The minimal solvent cleaning is a gravity fall out tank to allow any water or particulate material that may travel with the solvent, to settle to the bottom and be removed. These fall out material is less than 1% of the solvent recovery flow.

The above process produces two products, soil amendment and/or fertilizer and oil. Using the foregoing process, a hydrophilic soil amendment or fertilizer is produced that, through its water retention is advantageous to drier areas. The hydrophilic characteristics are achieved through the removal of oil. In prior art fertilizers, the sulfur is high, thereby retaining the oil and, in turn, preventing water from going into the plants.

The oil extracted using the disclosed method can be used as gas, diesel, marine vessels and asphalt production. There are seven critical components that must be combined in optimal degrees to produce the maximum amount of oil. results. As all systems require power and the longer the cycle takes the more power that is used.

Solvents: In lab testing ethyl acetate produced a higher yield than other solvents. However, when used at the industrial scale, ethyl acetate leaves more particulate matter than Heptane, making it less suited. This is unexpected and not consistent with previous lab testing where ethyl acetate seemed more promising. Ethyl acetate has a lower boiling point and an extracted equal or greater quantity of oil than Heptane, making ethyl acetate what seems to be an obvious choice. However, once testing was moved to industrial scale, it was found that Heptane provided a number of advantages over ethyl acetate, Heptane has higher boiling point (190° F.) than ethyl acetate (170° F.) allowing higher extraction temperatures around atmospheric pressures. Heptane's insolubility in water, vs. ethyl acetate's i soluable allows for simple gravity separation from water, reducing separation costs. Plus, it was found that heptane extracted the oil with less particulate matter than ethyl acetate. The use of ethyl acetate cause the sludge solids to breakdown and create more fines. This increase in fine also increase the amount of fines exiting with the oil.

This is not to eliminate the use of other solvents that may be advantageous in specific situations, but to note that heptane extracts more oil from the sludge with less material breakdown and therefore is preferred. As noted herein, each facility is tested optimal solvent for specific plants. Although blends of solvents will work, the ratios cannot vary greatly and it is difficult to maintain the proper percentages after recovery. Testing can be done after each recovery, however this greatly increases the cost while slowing production.

Particle size and particle penetration: The particle size directly affects the time and quantity of extraction. The solvent needs to penetrate the particle, overcoming the internal resistance. Therefore, although any size particle will work, the small the particles, the greater the quantity and the lower the time.

Temperature: During the process the solvents are maintained at a temperature in the range of about 10° F. to 20° F. below boiling. Heptane has the advantage of a boiling point of 180° F. while ethyl acetate boils at 17° F. and hexane, a non-polar solvent, boils at 156° F. The hotter the temperature the more oil extracted.

The dryer the sludge, the less expensive the subsequent processing, however not all of the water needs to removed. There are three types of moisture in the sludge; surface moisture accounts for approximately 70%; internal molecular 8%; and capillary adhesion 22%.

Using the system and equipment as disclosed above, the resulting solids are pathogen free and will meet the Class A Exceptional Quality Biosolids as set by Code 40 CFR part 503 as set forth at the time of filing. Roughly 99% of the solvent used in the extractor is cleaned and recycled through the system providing substantial savings. Additional savings are achieved through the use of the counter-current extractor through the reduction of temperature and pressure as well as smaller motor size. Using Heptane as the solvent produced a higher oil extraction with cleaner quality oil.

### BROAD SCOPE OF THE INVENTION

All documents, patents, journal articles and other materials cited in the present application are hereby incorporated by reference.

Although the present invention has been fully described in conjunction with several embodiments thereof with reference to the accompanying drawings, it is to be understood that various changes and modifications may be apparent to those skilled in the art. Such changes and modifications are to be understood as included within the scope of the present invention as defined by the appended claims unless they depart therefrom.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments) and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure, the following abbreviated terminology may be employed: “e.g.” which means “for example”.

What is claimed is:

1. The method of reclaiming usable products from sludge comprising the steps of:
a. drying said sludge;
b. transferring said sludge to an countercurrent extractor, said countercurrent extractor containing:
a. a solvent containing chamber having an entry end and an exit end, a predetermined level of a heated solvent;
b. multiple solids transfer members along a length of said solvent containing chamber;
c. an elevated solids removal member at said exit end, said removal member having a first end within said solvent to receive said solids from a last of said multiple solids transfer member and a second end elevated above said solvent and proximate a solids discharge port;
d. a solvent port proximate said second end of said elevated solids removal member and in liquid communication with said solids prior to entry of said discharge port;
e. a miscella exit port at said exit end, and
f. a sludge input port;
c. adding a single water insoluble solvent to said solvent containing chamber to a predetermined level;
d. heating and maintaining said single solvent at a predetermined temperature;
e. creating a current of solvent from said solvent port to said miscella exit port to separate miscella from said sludge leaving solids
f. adding said sludge at said sludge input port to contact a first of said multiple solids transfer members,
g. moving said sludge along said multiple solids transfer members to said solids removal member;
h. moving said solids along said solids removal member toward said discharge port;
i. spraying said solids with said solvent to remove additional miscella from said solids and maintain said predetermined level of said solvent;
j. removing said miscella at said miscella exit port;
K. transferring said miscella to at least one evaporator;
l. separating said solvent from said miscella within a first of said at least one evaporator;
m. removing residual solvent from said solids;
n. drying said solids; and
o. recycling said solvent to said extractor.

2. The method of claim 1 wherein said miscella is an oil/solvent mixture.

3. The method of claim 2 further comprising the step of separating oil from said oil/solvent mixture at said at least one evaporator.

4. The method of claim 1 wherein said solvent is heptane

5. The method of claim 1, wherein said sludge maintains contact with said solvent for an amount of time sufficient to produce a concentration of up to 25% oil in said solvent.

6. The method of claim 1, wherein the time period of said sludge contacting said solvent is sufficient to produce a solvent content of the solids upon exiting the extractor that is less than 30% solvent.

7. The method of claim 2, wherein at least 70% of said solvent is separated from said miscella upon leaving said extractor.

8. The method of claim 1, wherein said sludge is dried to a moisture content of below 25%.

9. The method of claim 1 wherein said extractor maintains said solvent at a temperature 10° F.-20° F. below said solvent boiling point;

10. The method of claim 1 wherein said solids are transferred to a desolventizer to remove remaining miscella from said solids.

11. The method of claim 1 wherein said solids are dried to about 10% moisture.

12. The method of claim 18 wherein said solids are used as a fertilizer meeting Class A Exception Quality Biosolids in accordance with Code 40 CFT part 503.

13. The method of claim 1 wherein said miscella is transferred to another of said at least one evaporator unto said miscella is at least about 99.9% oil.

14. The method of claim 1 wherein said oil remaining in said miscella is extracted from said solvent in an oil stripper.

15. The method of reclaiming usable products from sludge comprising the steps of:
a. drying said sludge to a moisture content of below 25%;
b. transferring said sludge to an countercurrent extractor, said countercurrent extractor containing:
i. a solvent containing chamber having an entry end and an exit end, a predetermined level of a heated solvent;
ii. multiple solids transfer members along a length of said solvent containing chamber;
iii. an elevated solids removal member at said exit end, said removal member having a first end within said solvent to receive said solids from a last of said multiple solids transfer member and a second end elevated above said solvent and proximate a solids discharge port;
iv. a solvent port proximate said second end of said elevated solids removal member and in liquid communication with said solids prior to entry of said discharge port;
v. a miscella exit port at said exit end, and
vi. a sludge input port;
c. adding Heptane to said solvent containing chamber to a predetermined level;
d. heating and maintaining said Heptane at a temperature 10° F.-20° F. below said Heptane boiling point;
e. creating a current of solvent from said solvent port to said miscella exit port to separate miscella from said sludge leaving solids;
f. adding said sludge at said sludge input port to contact a first of said multiple solids transfer members,
g. maintaining contact with said Heptane for an amount of time sufficient to produce a concentration of up to 25% oil in said Heptane;
h. moving said solids along said multiple solids transfer members to said solids removal member;
i. moving said solids along said solids removal member toward said discharge port;
j. spraying said solids with said Heptane to remove additional miscella from said solids exiting and maintain said predetermined level of said solvent;
k. removing said miscella at said miscella exit port;
l. transferring said miscella to at least one evaporator;
m. separating said miscella into oil and solvent within said evaporator;
n. transferring said solids to a desolventizer to remove remaining Heptane from said solids.
o. removing residual solvent from said solids;
p. drying said solids to about 10% moisture; and
q. recycling said Heptane to said extractor.

16. The method of claim 1 wherein said miscella is an oil/solvent mixture.

17. The method of claim 1, wherein the time period of said sludge contacting said solvent is sufficient to produce a solvent content of the solids upon exiting the extractor that is less than 30% solvent.

18. The method of claim 18 wherein said solids are used as a fertilizer or soil amendment meeting Class A Exception Quality Biosolids in accordance with Code 40 CFT part 503.

19. The method of claim 1 wherein said miscella is transferred to another of said least one evaporator until said miscella is about at least about 99.9% oil.

20. The method of claim 1 wherein said oil remaining in said miscella is extracted from said solvent in an oil stripper.
